(19) United States
(12) Patent Application Publication
(10) Pub. No.: US 2014/0015744 A1
(43) Pub. Date: Jan. 16, 2014

(54) CONTROL SYSTEM AND METHOD FOR A DISPLAY

(71) Applicants: Hon Hai Precision Industry Co., Ltd., New Taipei (TW); Hong Fu Jin Precision Industry (ShenZhen) Co., Ltd, Shenzhen (CN)

(72) Inventor: XIANG CAO, Shenzhen (CN)

(21) Appl. No.: 13/939,272

(22) Filed: Jul. 11, 2013

(30) Foreign Application Priority Data
Jul. 13, 2012 (CN) 2012102427074

(51) Int. Cl. G06F 3/00

(52) U.S. Cl. CPC G06F 3/002
USPC 345/156

(57) ABSTRACT

A control system for a display includes a number of motion sensors and a processor. The sensors detect objects and movement thereto and issue signals accordingly, the processor controlling the display to turn off after a set period without movement, and turn on again according to the detection of further movement, to save unnecessary display power.

### BACKGROUND

1. Technical Field

The present disclosure relates to a control system for a display.

2. Description of Related Art

Display equipment, such as a television, has been popular for decades. Sometimes, a user may leave for a certain time, such as half an hour, and then come back to watch the television. During the time of absence, the display equipment is still operating all the time, which waste energy.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a control system for a display, of the present disclosure, wherein the control system includes a processor.

FIG. 2 is a block diagram of the processor of FIG. 1.

FIG. 3 is an isometric view of the control system of FIG. 1.

FIG. 4 is a flow chart of an embodiment of a control method for a display, of the present disclosure.

### DETAILED DESCRIPTION

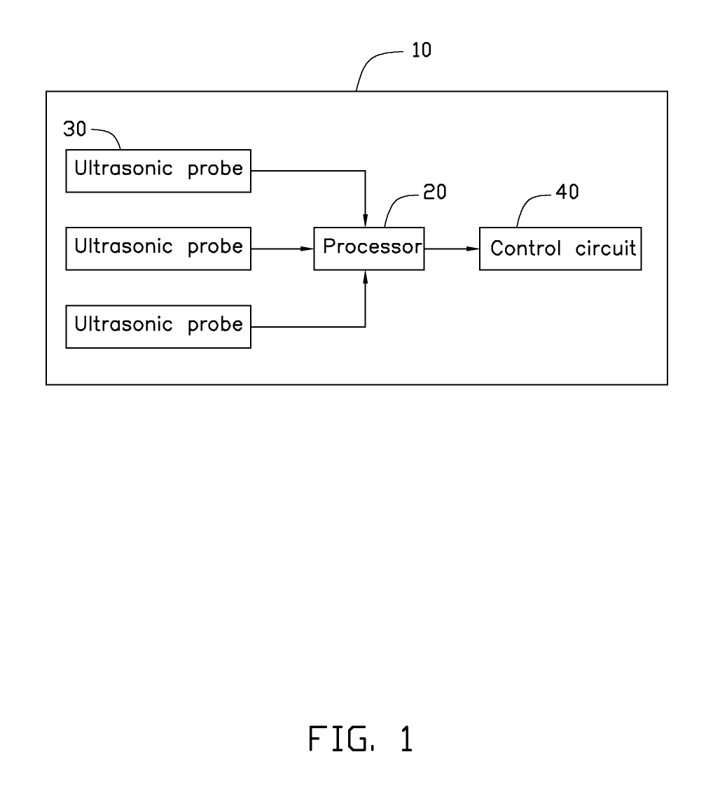

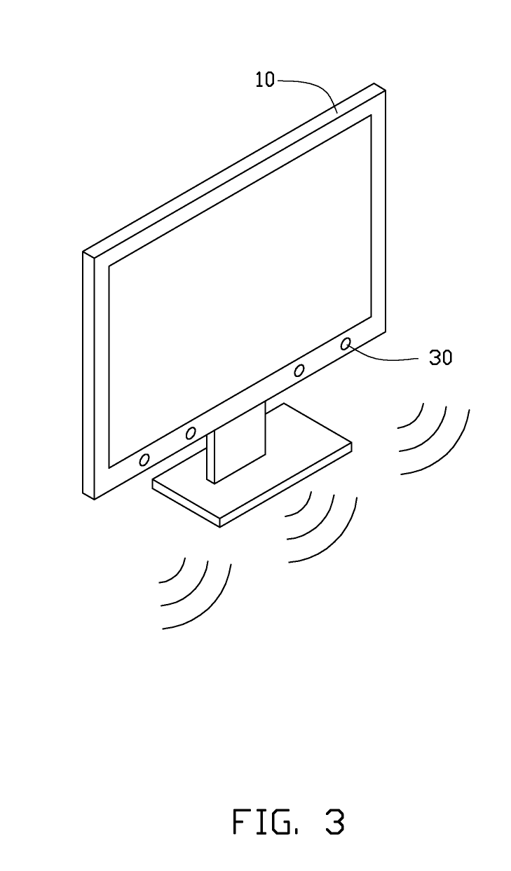

FIG. 1 illustrates an embodiment of a control system for a display 10 (shown in FIG. 3) of the present disclosure. The control system includes a plurality of motion sensors 30 arranged on the display 10, a processor 20, and a control circuit 40.

In the embodiment, the motion sensors 30 are ultrasonic probes 30. The ultrasonic probes 30 detect objects in front of the display 10, such as human beings, and output signals in relation to a movement of each object in front of the display 10.

The control circuit 40 controls the display 10 to turn on or turn off. When the display 10 is turned off, a part of electronic elements in the display 10 may stop operating, but the other parts of electronic elements, controlling the display 10 to turn on again, are still operating.

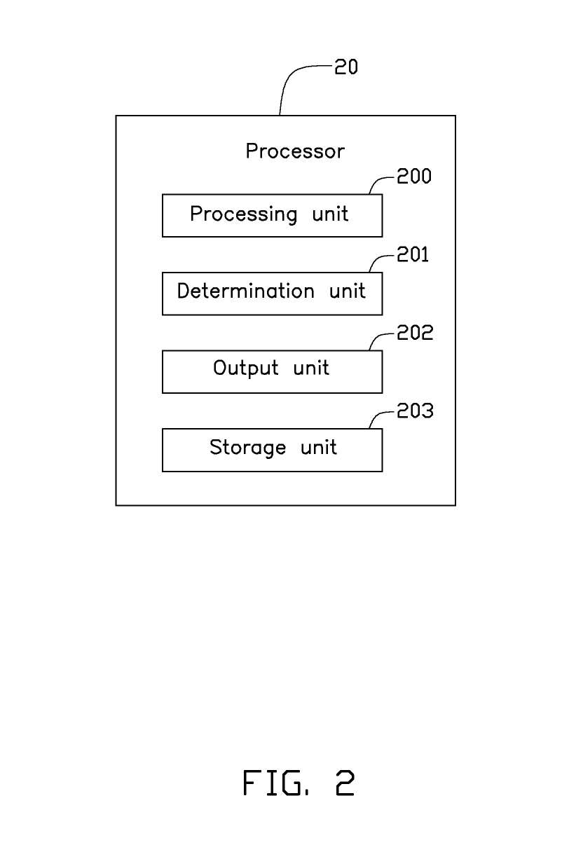

FIG. 2 shows that the processor 20 includes a processing unit 200, a determination unit 201, an output unit 202, and a storage unit 203.

The processing unit 200 receives the signals from the ultrasonic probes 30, and transmits the signals to the determination unit 201.

The storage unit 203 stores a first and a second predetermined time.

The determination unit 201 determines whether any movement in front of the display 10 is detected within the first predetermined time. If no movement is detected after the first predetermined time has elapsed, it indicates that there is no person in front of the display. The determination unit 201 then outputs a first control signal to the control circuit 40 through the output unit 202, to control the display 10 to turn off, thereby saving energy. If any movement in front of the display 10 is detected within the first predetermined time, the determination unit 201 obtains status of the display, such as being turned off or in operating state. If the determination unit 201 determines information that the display 10 is operating, the determination unit 201 outputs a second control signal to the control circuit 40, to maintain the display 10. Alternatively, if the determination unit 201 determines information that the display 10 is turned off; the determination unit 201 determines whether any movement in front of the display 10 is detected after the second predetermined time has elapsed. The determination unit 201 outputs a third control signal to the control circuit 40 in response to the movement being detected after the second predetermined time has elapsed, to control the display 10 to operate. The determination unit 201 outputs a fourth control signal to the control circuit 40 in response to the movement taking place before the end of the second predetermined time, to keep the display 10 in the turned off state.

FIG. 3 shows that four ultrasonic probes 30 are arranged on a bottom side of a front surface of the display 10.

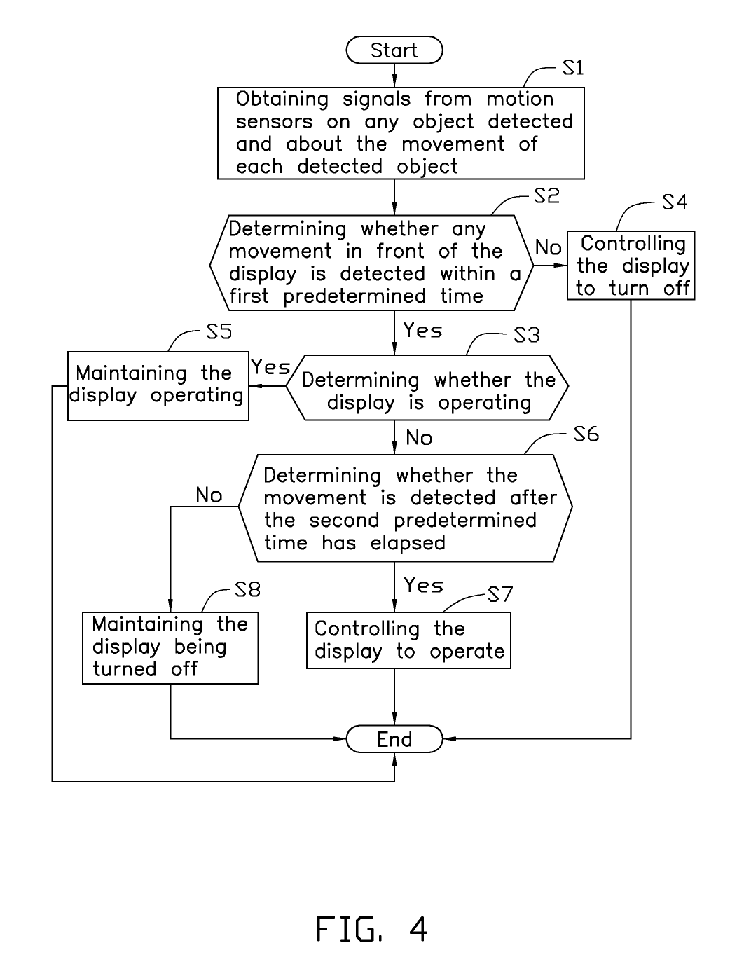

FIG. 4 shows an embodiment of a control method for the display 10, the control method includes the steps following.

In step S1, the processor 20 obtains signals from each ultrasonic probe 30 on any object detected and about the movement of each detected object.

In step S2, the processor 20 determines whether any movement in front of the display 10 is detected within a first predetermined time. If any movement in front of the display 10 is detected within the first predetermined time, step S3 is implemented; if no movement is detected after the first predetermined time has elapsed, step S4 is implemented.

In step S3, the processor 20 determines whether the display 10 is operating. If the display 10 is operating, step S5 is implemented; if the display 10 is turned off, step S6 is implemented.

In step S4, the processor 20 prompts the control circuit 40 to turn off the display 10.

In step S5, the processor 20 prompts the control circuit 40 to not turn off the display 10.

In step S6, the processor 20 determines whether the movement is detected after the second predetermined time has elapsed. If the movement is detected after the second predetermined time has elapsed, step S7 is implemented; if the movement takes place before the end of the second predetermined time, step S8 is implemented.

In step S7, the processor 20 prompts the control circuit 40 to turn on the display 10.

In step S8, the processor 20 prompts the control circuit 40 to continue the turned-off state of the display 10, to save energy.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A control system for a display, comprising:
a plurality of motion sensors configured to generate signals about movement of each object in front of the display;
a processor configured to receive the detection signals, comprising:
a processing unit configured to receive the signals from the plurality of motion sensors;
a determination unit configured to determine whether any movement is detected within a first predetermined time, wherein the determination unit outputs a first control signal in response to no movement being detected after the first predetermined time has elapsed; and
a control circuit configured to turn off the display in response to receiving the first control signal.

2. The control system of claim 1, wherein if any movement is detected within the first predetermined time, the determination unit obtains status of the display, when the display is operating, the determination unit outputs a second control signal to the control circuit, the control circuit maintains the display operating in response to receiving the second control signal; when the display is turned off, the determination unit determines whether any movement is detected after a second predetermined time has elapsed, if any movement is detected after the second predetermined time has elapsed, the determination unit outputs a third control signal to the control circuit, the control circuit controls the display to operate.

3. The control system of claim 2, wherein if the movement takes place before the end of the second predetermined time, the determination unit outputs a fourth control signal to the control circuit, the control circuit maintains the display being turned off in response to receiving the fourth control signal.

4. The control system of claim 3, wherein the plurality of motion sensors is ultrasonic probes.

5. The control system of claim 4, wherein the processor further comprises a storage unit, the first and second predetermined times are stored in the storage unit.

6. A control method for a display, the method comprising:
obtaining signals from a plurality of motion sensors about movement of each object in front of the display;
determining whether any movement is detected within a first predetermined time; and
controlling the display to turn off in response to no movement being detected after the first predetermined time has elapsed.

7. The control method of claim 6, further comprising:
obtaining status of the display in response to any movement being detected within the first predetermined time;
determining whether the display is operating; and
maintaining the display operating in response to the display operating.

8. The control method of claim 7, further comprising:
determining whether the movement is detected after a second predetermined time has elapsed in response to the display being turned off;
controlling the display to operate in response to the movement being detected after the second predetermined time has elapsed.

9. The control method of claim 8, further comprising:
maintaining the display being turned off in response to the movement taking place before the end of the second predetermined time.

10. The control method of claim 9, wherein the plurality of motion sensors is ultrasonic probes.
